(19) United States
(12) Patent Application Publication
(10) Pub. No.: US 2026/0251013 A1
(43) Pub. Date: Aug. 27, 2026

(54) BLIND COIL SPRING STRUCTURE AND BLIND

(71) Applicant: Changshu High-Tech Energy-Saving Dorwin Co., Ltd., Changshu (CN)

(72) Inventors: Chengzhe JIN, Changshu (CN); Xiangjun AN, Changshu (CN); Xi ZHOU, Changshu (CN); Xiaolei GAO, Changshu (CN); Jiajiang RONG, Changshu (CN)

(73) Assignee: Changshu High-Tech Energy-Saving Dorwin Co., Ltd., Changshu (CN)

(21) Appl. No.: 19/241,389

(22) Filed: Jun. 18, 2025

(30) Foreign Application Priority Data
Feb. 21, 2025 (CN) 202510192852.3

(51) Int. Cl. E06B 9/326; E06B 9/322; E06B 9/38

(52) U.S. Cl. CPC E06B 9/326; E06B 9/322; E06B 9/38

(57) ABSTRACT

The provided is a blind coil spring structure and a blind. The blind coil spring structure includes: a coil spring housing provided with a storage cavity, where the storage cavity is internally provided with multiple coil springs; a connection assembly configured to connect different coil springs in parallel; a lubrication assembly including a storage mechanism, a triggering mechanism, and a liquid outlet mechanism; and a vibration damping assembly including a contact mechanism and a damping mechanism, where the contact mechanism is configured to make the damping mechanism contact the coil spring; and the damping mechanism is configured to reduce a vibration generated during movement of the coil spring. The arrangement of the coil springs substantially reduces occupied internal space of the blind and significantly decreases the weight of the blind.

### CROSS-REFERENCE TO THE RELATED APPLICATIONS

This application is based upon and claims priority to Chinese Patent Application No. 202510192852.3, filed on Feb. 21, 2025, the entire contents of which are incorporated herein by reference.

### TECHNICAL FIELD

The present disclosure relates to the technical field of blinds, and in particular to a blind coil spring structure and a blind.

### BACKGROUND

With a growing demand for smart homes and modern architecture, blinds, as a crucial component for sunshade and privacy protection, have become common facilities in both residential and commercial spaces. Traditional blind systems often suffer from high friction, excessive noise, and short service life during operation, with component wear prone to occur particularly during frequent opening/closing operations. To extend service life and reduce noise, the present disclosure proposes a blind coil spring structure and a blind.

### SUMMARY

An objective of the present disclosure is to provide a blind coil spring structure and a blind, in order to solve the problems mentioned in the background section.

In order to achieve the above objective, the present disclosure provides the following technical solutions:

An aspect provides a blind coil spring structure, including:
a coil spring housing, provided with a storage cavity, where the storage cavity is internally provided with multiple coil springs;
a connection assembly, configured to connect different coil springs in parallel;
a lubrication assembly, disposed in the coil spring housing, and including a storage mechanism, a triggering mechanism, and a liquid outlet mechanism, where the storage mechanism is configured to store lubricating grease; the triggering mechanism is configured to trigger and activate the liquid outlet mechanism when the coil spring is stretched; and the liquid outlet mechanism is configured to release the lubricating grease from the storage mechanism to the coil spring; and
a vibration damping assembly, disposed in the storage cavity, and including a contact mechanism and a damping mechanism, where the contact mechanism is configured to make the damping mechanism contact the coil spring; and the damping mechanism is configured to reduce a vibration generated during movement of the coil spring.

Preferably, the coil springs are each provided with a connection groove; the connection assembly includes connecting screws; and the connecting screws are sequentially inserted into the connection grooves of different coil springs to connect the different coil springs.

Preferably, the storage mechanism includes a storage box; the storage box is disposed in the storage cavity; and the storage box is configured to store the lubricating grease.

Preferably, the storage cavity is provided with a rotating shaft; the triggering mechanism includes a rotating bearing, a threaded rod, and a piston; the rotating bearing is rotatably connected to the rotating shaft; the rotating bearing is coaxially connected to the threaded rod; the rotating bearing and the coil spring are fixedly connected; the piston is movably inserted in the storage box; when the coil spring drives the rotating bearing to rotate, the rotating bearing drives the threaded rod to rotate; and during rotation of the threaded rod, the piston moves along the storage box.

Preferably, the liquid outlet mechanism includes an extrusion member and a first pressure valve; the extrusion member is connected to the storage box; the extrusion member communicates with an interior of the storage box; and the first pressure valve is disposed at the extrusion member.

Preferably, the contact mechanism includes a mounting box, a telescopic rod, and a contact member; two sides of the mounting box are provided with the telescopic rod; the telescopic rod is connected to the contact member; and the contact member is made of a rubber material.

Preferably, the damping mechanism includes a damping spring; the damping spring is disposed inside the telescopic rod; and the damping spring is configured to reduce a vibration generated during movement of the coil spring.

Preferably, the damping mechanism further includes a connection tube; and two ends of the connection tube are connected to the extrusion member and the mounting box, respectively.

Preferably, the contact member is provided with a second pressure valve; and when the coil spring resets, the telescopic rod is compressed to open the second pressure valve.

Another aspect provides a blind, including the above blind coil spring structure.

Compared with the prior art, the present disclosure has the following beneficial effects. In the present disclosure, the arrangement of the coil springs substantially reduces occupied internal space of the blind and significantly decreases the weight of the blind. Meanwhile, the coil springs continuously pull an adjusting slider of the blind to maintain tension in a pull cord of the blind. Therefore, the coil springs enable the blind to remain stable and reliable during transportation and use. The selection of the appropriate coil springs in the blind facilitates labor-saving operation and enables reliable positioning of a blind curtain at any location within insulating glass. Through the arrangement of the lubrication assembly, the lubricating grease can be released to lubricate the coil spring during each use. Meanwhile, when the lubricating grease is extruded, a portion of the lubricating grease is delivered into the telescopic rod, further enhancing the anti-vibration capability of the vibration damping assembly during reset of the coil spring. This design demonstrates strong practical applicability.

### BRIEF DESCRIPTION OF THE DRAWINGS

FIG. 1 is a schematic diagram of a connection structure between a coil spring structure and a blind according to the present disclosure;

FIG. 2 is a schematic diagram of an internal structure of a storage cavity according to the present disclosure;

FIG. 3 is a schematic diagram of a mounting structure between a storage box and a connection tube according to the present disclosure;

FIG. 4 is a schematic diagram of an internal structure of the storage box according to the present disclosure; and

FIG. 5 is a schematic diagram of a connection structure between a telescopic rod and a damping spring according to the present disclosure.

Reference Numerals: 1. coil spring housing; 2. coil spring; 3. storage box; 4. rotating shaft; 5. rotating bearing; 6. threaded rod; 7. piston; 8. extrusion member; 9. first pressure valve; 10. mounting box; 11. telescopic rod; 12. contact member; 13. damping spring; 14. connection tube; 15. second pressure valve; 101. storage cavity; and 201. connection groove.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

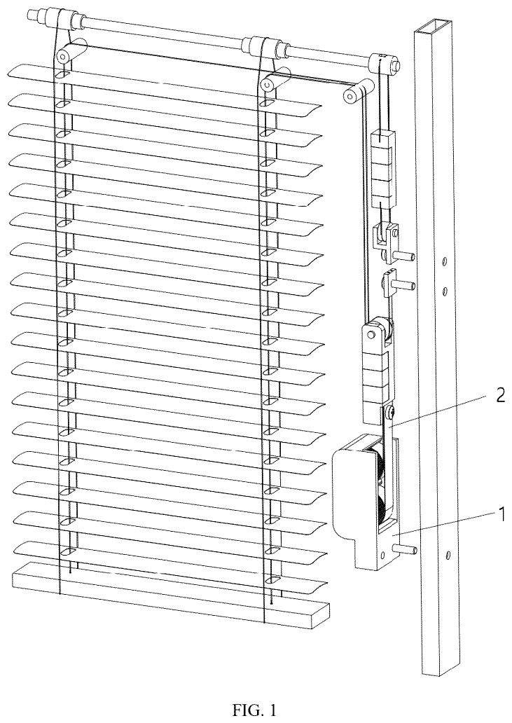

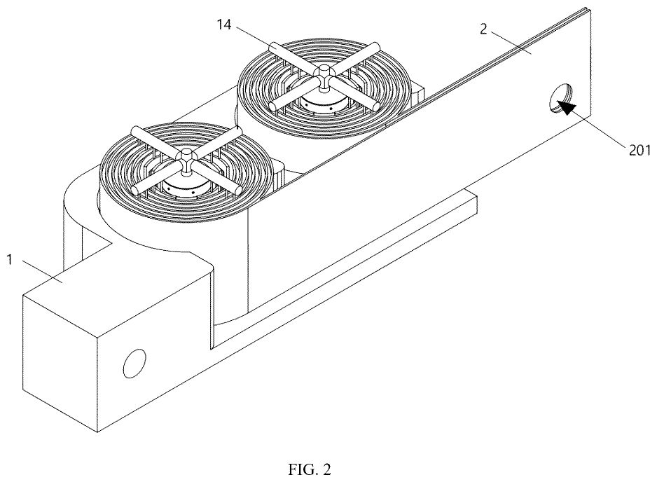

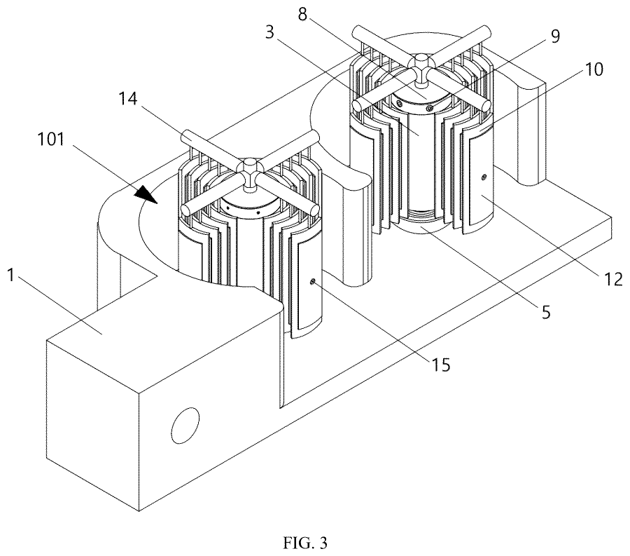

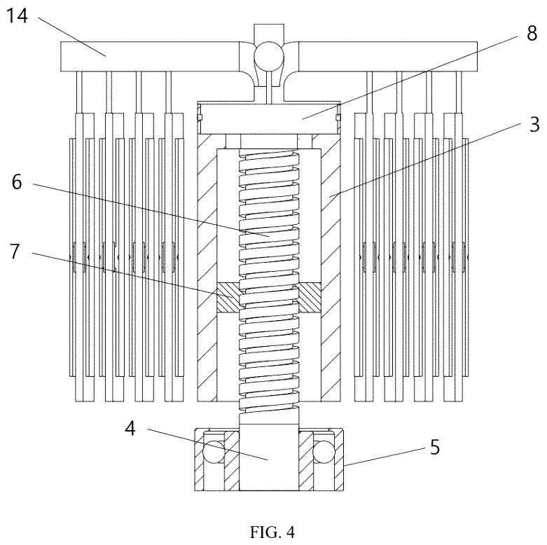

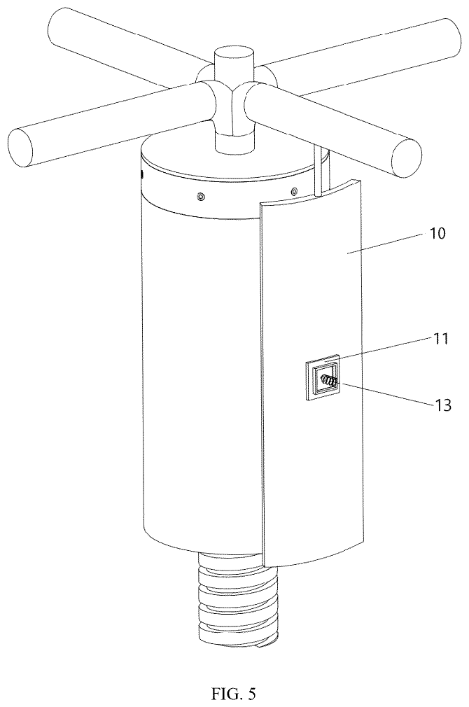

As shown in FIGS. 1 to 5, the present disclosure provides the following technical solution.

As shown in FIG. 1 of the specification, a blind coil spring structure includes: a coil spring housing, a connection assembly, a lubrication assembly, and a vibration damping assembly.

The coil spring housing 1 is provided with storage cavity 101. The storage cavity 101 is configured to mount coil springs 2. Specifically, the coil springs 2 are disposed in the storage cavity 101. The arrangement of the coil springs 2 substantially reduces occupied internal space of the blind and significantly decreases the weight of the blind. Meanwhile, the coil springs 2 continuously pull a slider of the blind to maintain tension in a pull cord. Therefore, the coil springs 2 enable the blind to remain stable and reliable during transportation and use while improving production efficiency. The selection of the appropriate coil springs 2 in the blind facilitates labor-saving operation and enables reliable positioning of a blind curtain at any location within insulating glass.

The connection assembly is configured to connect different coil springs 2 in parallel.

The lubrication assembly is disposed in the coil spring housing 1. The lubrication assembly includes a storage mechanism, a triggering mechanism, and a liquid outlet mechanism. The storage mechanism is configured to store lubricating grease. The triggering mechanism is configured to trigger and activate the liquid outlet mechanism when the coil spring 2 is stretched. The liquid outlet mechanism is configured to release the lubricating grease from the storage mechanism to the coil spring 2.

The vibration damping assembly is disposed in the storage cavity 101. The vibration damping assembly includes a contact mechanism and a damping mechanism. The contact mechanism is configured to make the damping mechanism contact the coil spring 2. The damping mechanism is configured to reduce a vibration generated during movement of the coil spring 2.

The coil springs 2 each are provided with connection groove 201. The connection groove 201 corresponds to a connecting screw. The connecting screws are configured to connect different coil springs 2 in parallel during use. The connecting screws each are further configured to fix one end of the coil spring 2 to a bottom of a lifting slider of the blind. The connection assembly includes the connecting screws which are sequentially inserted into the connection grooves 201 of different coil springs 2 to connect the different coil springs 2.

The storage mechanism includes storage box 3. The storage box 3 has a cylindrical structure. The storage box 3 is coaxially connected to threaded rod 6. The storage box 3 is disposed in the storage cavity 101. The storage box 3 is configured to store the lubricating grease.

The storage cavity 101 is provided with rotating shaft 4. The rotating shaft 4 is fixedly connected in the storage cavity 101. The triggering mechanism includes rotating bearing 5, the threaded rod 6, and piston 7. The rotating bearing 5 is rotatably connected to the rotating shaft 4. The rotating bearing 5 is configured to reduce friction between a reel and the rotating shaft 4 during use for noise reduction. The rotating bearing 5 is coaxially connected to the threaded rod 6. The rotating bearing 5 and the threaded rod 6 are fixedly connected. Therefore, when the coil spring 2 drives the rotating bearing 5 to rotate, the threaded rod 6 rotates correspondingly. The threaded rod 6 is a unidirectional motion screw rod that effectively prevents reverse movement of the piston 7. The rotating bearing 5 is fixedly connected to one end of the coil spring 2. The piston 7 is movably inserted in the storage box 3. When the coil spring 2 drives the rotating bearing 5 to rotate, the rotating bearing 5 drives the threaded rod 6 to rotate. During rotation of the threaded rod 6, the piston 7 moves along the storage box 3.

The liquid outlet mechanism includes extrusion member 8 and first pressure valve 9. The extrusion member 8 is fixedly connected to the storage box 3. The extrusion member 8 communicates with an interior of the storage box 3. The first pressure valve 9 is annularly disposed around the extrusion member 8. The first pressure valve 9 is configured to extrude the lubricating grease from the extrusion member 8 when pressure in the extrusion member 8 exceeds a set range of the first pressure valve 9.

The contact mechanism includes mounting box 10, telescopic rod 11, and contact member 12. The mounting box 10 is configured to mount the telescopic rod 11 and the contact member 12. Two sides of the mounting box 10 are provided with the telescopic rod 11. The telescopic rod 11 is connected to the contact member 12. The contact member 12 is made of a rubber material. The rubber contact member 12 effectively absorbs and eliminates vibrations and noises during use.

The damping mechanism includes damping spring 13. The damping spring 13 is disposed inside the telescopic rod 11. The damping spring 13 is configured to further reduce a vibration generated during movement of the coil spring 2. The damping spring 13 is further configured to enhance contact effect between the contact member 12 and the coil spring 2.

The damping mechanism further includes connection tube 14. Two ends of the connection tube 14 are connected to the extrusion member 8 and the mounting box 10, respectively. The connection tube 14 is configured to communicate the extrusion member 8 with the mounting box 10. The mounting box 10 communicates with the telescopic rod 11. Therefore, when the piston 7 compresses the lubricating grease in the storage box 3, the lubricating grease in the storage box 3 is extruded into the mounting box 10. The lubricating grease entering the mounting box 10 further enhances anti-vibration capability of the telescopic rod 11.

The contact member 12 is provided with second pressure valve 15. When the coil spring 2 resets, the telescopic rod 11 at one side of the mounting box 10 is compressed to open the second pressure valve 15.

The working principle is as follows. During use, the coil spring 2 is pulled to drive the rotating bearing to rotate. When the rotating bearing 5 rotates, the threaded rod 6 is driven to rotate, thereby driving the piston 7 to move along the storage box 3. When the piston 7 moves along the storage box 3, the lubricating grease in the storage box 3 is extruded into the extrusion member 8. The stored grease in the extrusion member 8 is first delivered to the mounting box 10. When the stored grease in the mounting box 10 and the telescopic rod 11 reaches storage limits, the lubricating grease is output through the first pressure valve 9 and the second pressure valve 15 to lubricate the coil spring 2 and prevent rust.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

What is claimed is:

1. A blind coil spring structure, comprising:
a coil spring housing, provided with a storage cavity, wherein the storage cavity is internally provided with a plurality of coil springs;
a connection assembly, configured to connect the plurality of coil springs in parallel;
a lubrication assembly, disposed in the coil spring housing, and comprising a storage mechanism, a triggering mechanism, and a liquid outlet mechanism, wherein the storage mechanism is configured to store lubricating grease; the triggering mechanism is configured to trigger and activate the liquid outlet mechanism when the coil spring is stretched; and the liquid outlet mechanism is configured to release the lubricating grease from the storage mechanism to the coil spring; and
a vibration damping assembly, disposed in the storage cavity, and comprising a contact mechanism and a damping mechanism, wherein the contact mechanism is configured to make the damping mechanism contact the coil spring; and the damping mechanism is configured to reduce a vibration generated during movement of the coil spring.

2. The blind coil spring structure according to claim 1, wherein the coil springs are each provided with a connection groove; the connection assembly comprises connecting screws; and the connecting screws are sequentially inserted into the connection grooves of the plurality of coil springs to connect the plurality of coil springs.

3. The blind coil spring structure according to claim 1, wherein the storage mechanism comprises a storage box; the storage box is disposed in the storage cavity; and the storage box is configured to store the lubricating grease.

4. The blind coil spring structure according to claim 3, wherein the storage cavity is provided with a rotating shaft; the triggering mechanism comprises a rotating bearing, a threaded rod, and a piston; the rotating bearing is rotatably connected to the rotating shaft; the rotating bearing is coaxially connected to the threaded rod; the rotating bearing and the coil spring are fixedly connected; the piston is movably inserted in the storage box; when the coil spring drives the rotating bearing to rotate, the rotating bearing drives the threaded rod to rotate; and during rotation of the threaded rod, the piston moves along the storage box.

5. The blind coil spring structure according to claim 1, wherein the liquid outlet mechanism comprises an extrusion member and a first pressure valve; the extrusion member is connected to a storage box; the extrusion member communicates with an interior of the storage box; and the first pressure valve is disposed at the extrusion member.

6. The blind coil spring structure according to claim 5, wherein the contact mechanism comprises a mounting box, a telescopic rod, and a contact member; two sides of the mounting box are provided with the telescopic rod; the telescopic rod is connected to the contact member; and the contact member is made of a rubber material.

7. The blind coil spring structure according to claim 6, wherein the damping mechanism comprises a damping spring; the damping spring is disposed inside the telescopic rod; and the damping spring is configured to reduce a vibration generated during movement of the coil spring.

8. The blind coil spring structure according to claim 7, wherein the damping mechanism further comprises a connection tube; and two ends of the connection tube are connected to the extrusion member and the mounting box, respectively.

9. The blind coil spring structure according to claim 8, wherein the contact member is provided with a second pressure valve; and when the coil spring resets, the telescopic rod is compressed to open the second pressure valve.

10. A blind, comprising the blind coil spring structure according to claim 1.

11. The blind according to claim 10, wherein in the blind coil spring structure, the coil springs are each provided with a connection groove; the connection assembly comprises connecting screws; and the connecting screws are sequentially inserted into the connection grooves of the plurality of coil springs to connect the plurality of coil springs.

12. The blind according to claim 10, wherein in the blind coil spring structure, the storage mechanism comprises a storage box; the storage box is disposed in the storage cavity; and the storage box is configured to store the lubricating grease.

13. The blind according to claim 12, wherein in the blind coil spring structure, the storage cavity is provided with a rotating shaft; the triggering mechanism comprises a rotating bearing, a threaded rod, and a piston; the rotating bearing is rotatably connected to the rotating shaft; the rotating bearing is coaxially connected to the threaded rod; the rotating bearing and the coil spring are fixedly connected; the piston is movably inserted in the storage box; when the coil spring drives the rotating bearing to rotate, the rotating bearing drives the threaded rod to rotate; and during rotation of the threaded rod, the piston moves along the storage box.

14. The blind according to claim 10, wherein in the blind coil spring structure, the liquid outlet mechanism comprises an extrusion member and a first pressure valve; the extrusion member is connected to a storage box; the extrusion member communicates with an interior of the storage box; and the first pressure valve is disposed at the extrusion member.

15. The blind according to claim 14, wherein in the blind coil spring structure, the contact mechanism comprises a mounting box, a telescopic rod, and a contact member; two sides of the mounting box are provided with the telescopic rod; the telescopic rod is connected to the contact member; and the contact member is made of a rubber material.

16. The blind according to claim 15, wherein in the blind coil spring structure, the damping mechanism comprises a damping spring; the damping spring is disposed inside the telescopic rod; and the damping spring is configured to reduce a vibration generated during movement of the coil spring.

17. The blind according to claim 16, wherein in the blind coil spring structure, the damping mechanism further comprises a connection tube; and two ends of the connection tube are connected to the extrusion member and the mounting box, respectively.

18. The blind according to claim 17, wherein in the blind coil spring structure, the contact member is provided with a second pressure valve; and when the coil spring resets, the telescopic rod is compressed to open the second pressure valve.
